(19) United States
(12) Patent Application Publication
(10) Pub. No.: US 2026/0210424 A1
(43) Pub. Date: Jul. 23, 2026

(54) CORD RATCHET

(71) Applicant: JAMESON, LLC, Clover, SC (US)

(72) Inventor: Blake Andrew Tomlinson, Statesville, NC (US)

(21) Appl. No.: 19/028,711

(22) Filed: Jan. 17, 2025

(51) Int. Cl. F16G 11/10; A01G 3/08; B25G 1/04

(52) U.S. Cl. CPC F16G 11/10; A01G 3/08; B25G 1/04

(57) ABSTRACT

A cord ratchet device includes a mounting base defining a longitudinally extending pole channel for receiving a pole. A yoke is rigidly connected to the mounting base. The yoke defines a cord path. A lever is pivotally mounted on the yoke. The lever includes a pawl for engaging a cord by movement of the pawl thereby varying a dimension of the cord path. The pawl automatically permits cord movement in a first longitudinal direction, and automatically prevents cord movement in an opposite second longitudinal direction. The yoke includes two flanges between which the cord path is defined. The pawl is pivotally mounted to the yoke between the two flanges. The cord path is defined between the two flanges and between the pawl and a floor defined by an exterior of the mounting base between the two flanges. The dimension of the cord path is defined between the pawl and floor.

### TECHNICAL FIELD

The present disclosure relates to pole mounted tools, specifically devices to control ropes used in such tools. More specifically, the disclosure relates to a rope ratchet device that enhances functionality and ease of use of pole mounted pruning tools.

### BACKGROUND

Pole mounted pruning tools are commonly employed in horticulture and forestry to trim branches and foliage that are otherwise out of reach. These tools typically use a rope or cable system to operate a cutting mechanism located at the end of a long pole. The rope allows the user to maneuver the cutting mechanism from a distance, but managing and controlling the rope can be challenging.

Traditionally, pulley-based systems have been employed to facilitate rope movement and control in pole mounted pruning tools. These systems use one or more pulleys to guide the rope, reducing the friction and providing mechanical advantage. While pulleys can enhance the efficiency of rope movement and reduce the physical effort required by the user, they often present limitations in terms of precise control and secure locking of the rope.

Typical pole pruners are designed to be attached at the top end of a fiberglass pole, so they can reach elevated tree branches. A typical pole pruner is activated by pulling a cord to rotate a lever that actuates the cutting blade action of the pruner. The rope is typically long enough to reach the user at the bottom end of the pole, so that the user can pull the rope to actuate the lever and cut the desired branch, vine, or other element.

Existing pulley systems may include simple fixed pulleys or compound pulley setups to assist in rope management. The addition of a second pulley increases the mechanical advantage of the system, and reduces the effort required by the user to produce the cutting movement. However, it also doubles the length of rope required to produce the same cutting blade movement. In some instances, the distance the rope must be pulled may be so long that it may require the user to assume postures that fall outside of ergonomical recommendations, or indeed exceed the anatomical capabilities of the user.

Therefore, improvements are needed to address the limitations of current pulley-based systems in pole mounted pruning tools.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

In at least one embodiment, a cord ratchet device includes a mounting base defining a longitudinally extending pole channel for receiving a pole. A yoke is rigidly connected to the mounting base. The yoke defines a cord path. A lever is pivotally mounted on the yoke. The lever includes a pawl for engaging a cord by movement of the pawl thereby varying a dimension of the cord path.

The pawl can automatically permit cord movement in a first longitudinal direction, and automatically prevent cord movement in an opposite second longitudinal direction.

The yoke may include two flanges between which the cord path is defined.

The lever may be pivotally mounted on the yoke by way of the pawl being pivotally mounted to the yoke between the two flanges.

In some examples, the cord path is defined between the two flanges and between the pawl and a floor defined by an exterior of the mounting base between the two flanges, where the dimension of the cord path is defined between the pawl and floor.

The pawl may be pivotally mounted to the yoke at a pivot axis, and an end of the pawl may have a curved edge along which a varying radius from the pivot is defined thereby varying said dimension of the cord path when the lever is pivoted.

The lever may have a locking position, at which the dimension of the cord path is minimized, and a release position defined by pivoting the lever away from the locking position thereby increasing the dimension.

The dimension of the cord path may be defined between the floor and a nearest tangent point along the curved edge nearest the floor.

The cord ratchet device may include pawl-mounted engagement teeth distributed along the curved edge and extended toward the floor and into the cord path.

The cord ratchet device may include fixed engagement teeth extending from the floor into the cord path and toward the pawl.

The fixed engagement teeth and/or the pawl-mounted engagement teeth may be inclined in a longitudinal first direction.

An axle may be passed through a pivot hole defined through the pawl at the pivot axis, the axle mounting the lever to the yoke.

The axle may be defined by a lever fastener having a shank by which the lever is pivotally mounted to the yoke; and the shank may include a first portion received in a mounting hole in a first of the two flanges and a second portion received in a mounting hole in a second of the two flanges.

The lever may include a laterally extending portion connected to the pawl, an intermediate portion connected to the laterally extending portion, and a longitudinally extending handle connected to the laterally extending portion by way of the intermediate portion.

The mounting base may include a main body and a clasp pivotally connected to the main body. The main body may define the pole channel and the clasp may define another longitudinally extending channel, the pole channel and the channel of the clasp together surrounding a longitudinal axis and defining a pole bore in a closed position of the clasp.

The main body may include a circumferential shell having a longitudinally extending first edge and an opposite longitudinally extending second edge. The clasp may include a circumferential shell having a longitudinally extending first edge and an opposite longitudinally extending second edge. The first edge of the clasp may be pivotally attached to the first edge of the main body.

The cord ratchet device may further include a clasp fastener releasably coupling the second edge of the clasp to the second edge of the main body releasably maintaining the clasp in the closed position. When the clasp is in the closed position, the circumference defined by the clasp and the body is slightly smaller than that of the pole that it attaches to, such that enough friction is created so that no relative movement between the pole and the ratchet device is possible.

The second edge of the main body may include an azimuthally directed plate including a threaded hole. The second edge of the clasp may include an azimuthally directed plate that carries the clasp fastener. The clasp fastener may include a shank having a threaded end releasably engaging the threaded hole.

A pole pruner assembly, according to at least one embodiment, for which the above examples and options apply as well, includes a longitudinally extending pole, a pruner device mounted on an end of the pole, and a cord rachet device having a mounting base mounted on the pole, at a location along the pole such that it is easily accessible by the user. The pruner device is actuated by manual pulling of a cord in a pull direction along the pole. The cord rachet device includes a yoke rigidly connected to the mounting base. The yoke defines a cord path through which the cord extends. A lever is pivotally mounted on the yoke. The lever includes a pawl for engaging the cord by movement of the pawl thereby varying a dimension of the cord path.

The pawl may automatically permit cord movement in the pull direction, and may automatically prevent cord movement in an opposite release direction.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. Various combinations of features shall be deemed supported whether or not appearing expressly in the drawings and descriptions. No combination of features shall be deemed unsupported for merely not appearing expressly in the drawings and descriptions.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 is a perspective view of an embodiment of a cord ratchet.

FIG. 2 is another perspective view of the cord ratchet of FIG. 1.

FIG. 3 is a perspective view of the cord ratchet of FIG. 1 with the hinged clasp in an open position.

FIG. 4 is a partially exploded perspective view of the cord ratchet as in FIG. 3.

FIG. 5 is a longitudinal view of the cord ratchet of FIG. 1 along the pole bore and cord path.

FIG. 6 is a sectional perspective view taken along the line 6-6 in FIG. 5.

FIG. 7 is a is a perspective view of the cord ratchet mounted on a pole with the hinged clasp open as in FIG. 4, showing also a cord passed through the cord channel.

FIG. 8 is a sectional perspective view taken along the line 8-8 in FIG. 5, shown mounted on a pole in dashed line, also showing the cord as in FIG. 8.

FIG. 9 is an illustration of a pole pruner in use without a cord ratchet.

FIG. 10 is an illustration of the pole pruner assembly including the cord ratchet of FIG. 1.

FIG. 11 is a perspective view of an embodiment of a cord ratchet according to another embodiment, with the hinged clasp shown in a closed position.

FIG. 12 is a perspective view of the cord ratchet of FIG. 11, with the hinged clasp in an open position.

FIG. 13 is a side view of the cord ratchet of FIG. 11.

FIG. 14 is a longitudinal view of the cord ratchet of FIG. 11 along the pole bore and cord path.

FIG. 15 is an exploded perspective view of the cord ratchet as in FIG. 11.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Any materials described are provided as non-limiting examples except where their inclusion is positively and unambiguously asserted. Once materials and arrangements are described herein with reference to any structures and elements thereof, for example in the drawings, such descriptions apply as well to any further same or similar structures and elements that may appear in other drawings.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains. The terms cord and rope are used interchangeably and refer to any tensile flexible line suitable for use with the described and illustrated ratchets. These terms refer to lines including synthetic materials and/or natural materials, multi-filament lines, and monofilament lines.

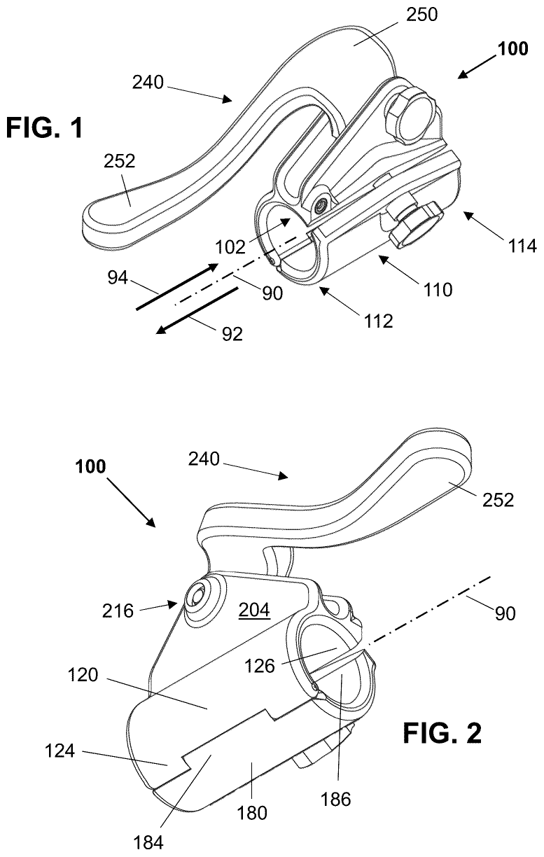

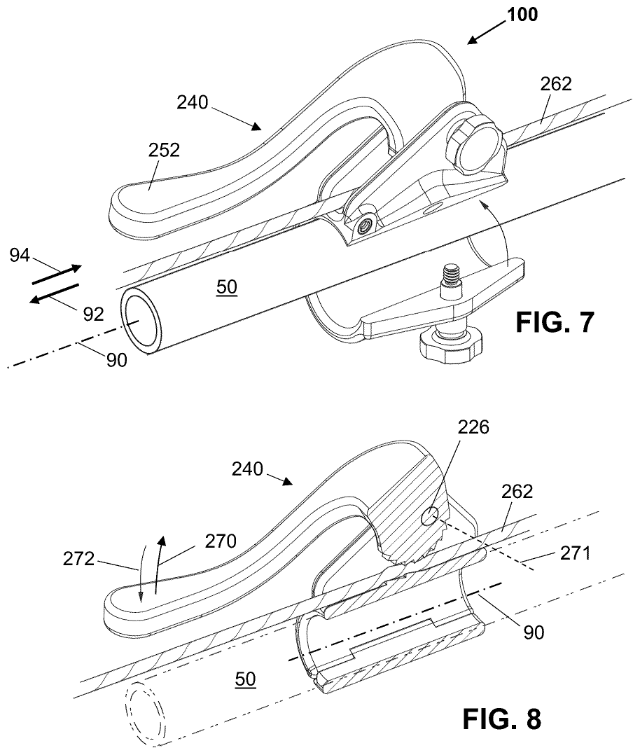

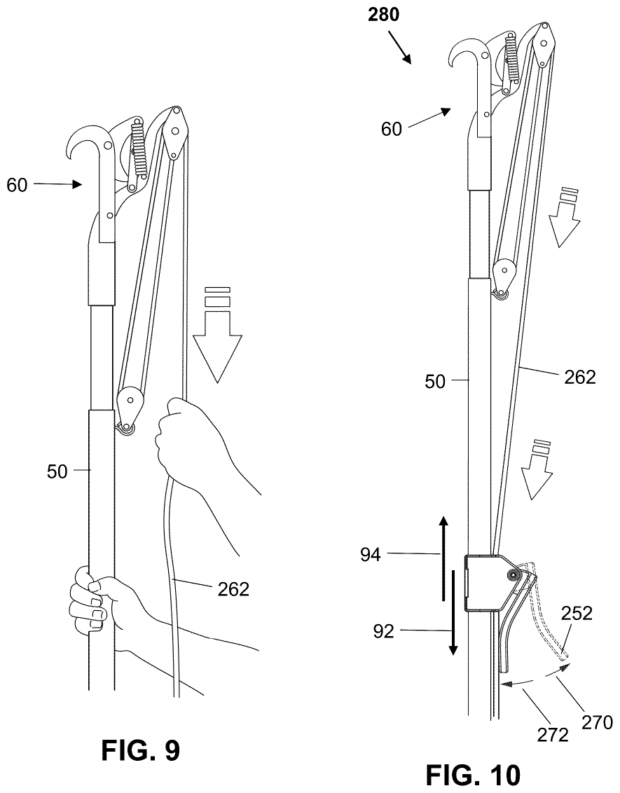

The illustrated embodiment of the cord ratchet 100 (FIGS. 1-5) mounts securely at any position along the length of a pole 50 (FIGS. 7-8, 10). The cord ratchet has a clasp design that opens to allow mounting onto a pole mid-span or any desired location, and securely closes in place with a convenient thumb screw. Advantageously, the cord ratchet 100 can be mounted close to the user, so it can be conveniently actuated as part of the pull reset of a cord actuated device 60, illustrated as a pole-mounted pruner device for a non-limiting example. For illustration of its use, see FIG. 10 before proceeding with the below descriptions of the structure and details of the cord ratchet.

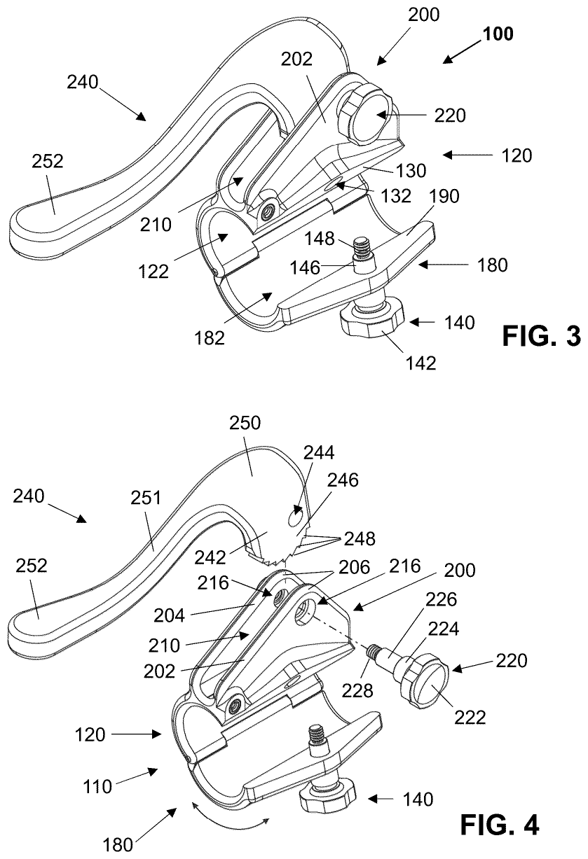

Referring to FIG. 1, the cord ratchet 100 has a mounting base 110 defining an interior pole bore 102 that receives a pole when installed for use. The mounting base 110 includes a main body 120 and a clasp that cooperatively define the bore and secure the cord ratchet 100 to a pole when installed. The main body 120 defines a semicylinder pole channel 122 (FIG. 3), which is shaped as semi-circular with a uniform radius when viewed along a longitudinal axis 90 in the illustrated embodiment. The clasp 180 similarly defines a semicylinder pole channel 182. The pole channels 122 and 182 receive respective portions of a pole when mounting the cord ratchet thereto. The channels 122 and 182 together define the pole bore 102 surrounding the longitudinal axis 90 upon closure of the clasp 180 relative to the main body 120. The defined pole bore 102 has a diameter that is nominally slightly smaller than that of the pole it is intended to be mounted onto, such that friction is created and no relative movement between the two is possible. The longitudinal axis serves as a convenient term with respect to which features perpendicular thereto can be described as lateral.

The described embodiment, having the semicylinder channels together defining a circularly cylindrical pole bore, corresponds to expected use with a longitudinally extending circularly cylindrical pole having a uniform diameter as in the drawings. As other poles may be available or conceived in view of these descriptions, other embodiments of the main body and cooperating clasp may together define a pole bore with other corresponding shapes.

The main body 120 is nominally described herein as stationary with respect to other elements, which are described nominally as pivoting or rotating for convenient convention. For another convenient descriptive convention, a pull direction 92 and an opposite release direction 92 are referenced in the drawings along or parallel the longitudinal axis 90. A longitudinal first end 112 of the mounting base 110 faces the pull direction 92, and an opposite longitudinal second end 114 of the mounting base faces the release direction 94. These conventions are intuitive with respect to use of the cord ratchet 100 as in FIG. 10 as will become apparent in view of the below further descriptions.

The main body 120 is formed as a rigid circumferential shell in the illustrated embodiment, having a longitudinally extending first edge 124 (FIG. 2) and an opposite second edge 126. The clasp 180, also formed as a rigid circumferential shell, similarly has a first longitudinally extending first edge 184 and an opposite second edge 186. The first edge 124 is pivotally attached to the first edge 184. A pinned hinge design is represented in drawings. Other pivotal connections, including a living hinge, are within the scope of these descriptions.

The second edge 126 of the main body 120 has an azimuthally directed plate 130 (FIG. 3) for engaging the second edge 186 of the clasp, having an oppositely azimuthally directed plate 190. The plate 130 of the main body 120 is releasably coupled to the plate 190 of the clasp 180 selectively by a clasp fastener in the illustrated embodiment.

The clasp fastener is illustrated as a thumb screw 140 (FIG. 3) generally carried by the clasp 180 and as having a head represented as a knurled knob 142. A staged shank extends from the head. The shank has a smooth unthreaded neck 146 extending from the knob 142 and through the clasp plate 190. The neck 146 turns freely to permit turning of the fastener. The thumb screw 140 is captured. Once installed on the clasp it cannot be disassembled. A threaded end 148 of the shank extending from and diametrically reduced relative to the neck 146 engages a threaded hole 132 in the plate 130 of the main body 120. By disengaging the fastener 140 from the main body 120, the clasp 180 can pivot at its first edge 184 to open the mounting base 110 as shown in FIG. 3. This permits placement of the cord ratchet 100 to any position along a pole preferred by a user. The clasp 180 can then be pivoted to its closed position (FIGS. 1-2) and the fastener 140 is used to re-engage the main body 120 by turning the threaded end 148 into the threaded hole 132, thereby tightening the mounting base 110 around the pole and fixing its location.

A rigid fixed yoke 200 is connected to and extends outwardly from the exterior of the main body 120 of the mounting base 110, nearer the second edge than the first edge in the illustrated embodiment. The fixed yoke 200, which serves as a fulcrum for a pivotally mounted lever 240, is defined by two uniformly spaced parallel flanges (202, 204), each having a base connected to the main body 120 of the mounting base 210, each having an outward extending apex 206 (FIG. 4), and together defining a channel 210 for receiving the pivoting lever 240 and cord 262. A floor 212 of the channel 210 is defined by the exterior of the main body 120 of the mounting base 110 between the bases of the flanges (202, 204).

Each flange (202, 204) has a respective mounting hole 216 (FIG. 4) at its apex 206. The mounting holes 216 are aligned to receive respective portions of a lever fastener having a portion that serves as an axle by which the pivoting lever 240 is mounted on the fixed yoke 200. The lever fastener is illustrated as a thumb screw 220, which includes head represented as a knurled knob 222 and a staged shank extending from the head. The shank has a centering insert 224 extending from and diametrically reduced relative to the head, a smooth unthreaded neck 226 extending from and diametrically reduced relative to the centering insert 224, and a threaded end 228 extending from and diametrically reduced relative to the neck 226. The neck 226 serves as an axle on which the lever pivots.

A pawl 242 of the lever 240 is received into the channel 210 between the flanges, for installation, and includes a pivot hole 244 (FIG. 4) that aligns with the mutually aligned fixed mounting holes 216 of the flanges (202, 204), trapping the pawl 242 in the channel 210 between the flanges when assembled and thereby pivotally mounting the lever to the mounting base 110. The outer side of the first flange 202 has a receiving well around its mounting hole 216 that matingly receives the centering insert 224, stabilizing the thumb screw 220. The mounting hole 216 of the second flange 204 is threaded to receive and engage the threaded portion 228. The neck 226 serving as an axle is passed through the pivot hole 244 during installation, and permits the lever 240 to freely pivot relative to the fixed yoke 200 but remain pivotally attached.

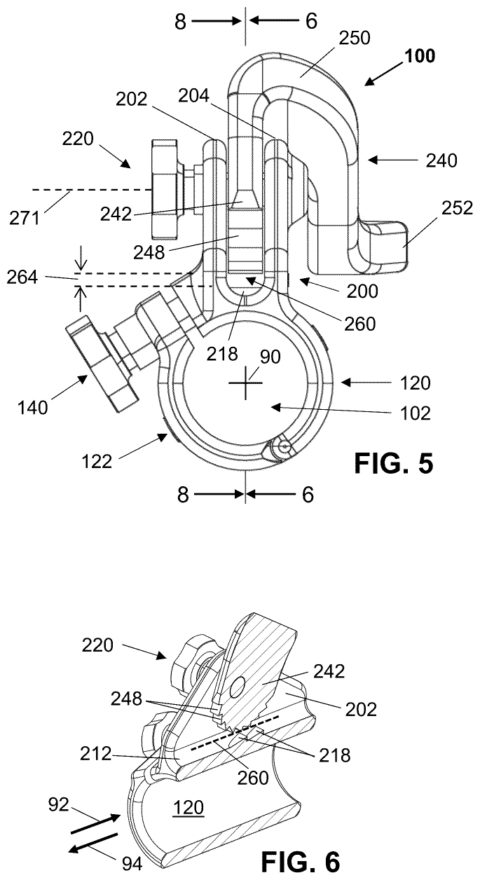

Installation of the lever 240 defines a cord path 260 (FIGS. 5-6) bounded laterally by the opposed fixed bases of the flanges (202, 204), such that a lateral dimension of the cord path is fixed. The cord path 260 is bounded inwardly by the floor 212 of the channel 210, and outwardly by the opposing end of the pawl 242. The generally inwardly facing end of the pawl 242 is arcuate around the pivot hole 244 and neck 226 that serves as an axle to the lever. The end of the pawl 242 has a curved edge 246 (FIG. 4) along which a varying radius from the pivot axis through the pivot hole 244 and axle is defined. The curved edge 246 thus varies a dimension 264 (FIG. 5) of the cord path 260 between the floor 212 and nearest tangent point along the end of the pawl 242 as the lever 240 pivots, locking the cord 262 from movement particularly in the release direction 94 when the lever 240 reaches a locking position, minimizing the dimension 264 and squeezingly engaging the cord.

To improve engagement of the mounting base 110 and cord 262, fixed cord engagement teeth 218 (FIG. 6) extend from the floor 212 into the cord path 260 (FIG. 6) and toward the pawl 242. To improve engagement of the pawl 242 and cord 262, pawl-mounted cord engagement teeth 248 (FIG. 4) are distributed along the curved edge 246 and extend toward the floor 212 and into the cord path 260. Referring to both the fixed cord engagement teeth 218 (FIG. 6) and pawl-mounted cord engagement teeth 248 (FIG. 4), each engagement tooth is inclined toward the pull direction 92 improving cord engagement particularly in resisting movement of the cord in the release direction 94.

The lever 240 includes a laterally extending portion 250 (FIG. 5) connected to the pawl 242, an intermediate portion 251 connected to the laterally extending portion 250, and a longitudinally extending handle 252 connected to the laterally extending portion 250 by way of the intermediate portion 251. The laterally extending portion 250 thus advantageously spaces movement of the handle 252 from a pole when the lever 240 is pivoted to actuate the cord ratchet 100. This makes use of the lever 240 by the user convenient when controlling the locked versus released status of the cord 262.

The laterally extending portion 250 advantageously extends in a lateral direction from the yoke opposite the head of the thumb screw represented as the knurled knob 222, thus leaving the head unobstructed for reach by a user in any position of the lever 240. An intermediate portion 251 (FIG. 4) of the lever 240 between the portion 250 and the handle 252 makes the end of the handle 252 closer to the pole. This makes its actuation (release) easier because the user would naturally put his hand on the pole for normal use. It also changes the center of gravity such the lever falls into its closed position automatically by gravity when the pole is in vertical orientation. This allows the system to work better because it engages and locks the cord automatically.

The lever 240 is generally shown in its locking position throughout the drawings. The release position of the lever is represented in FIG. 10 where the handle 252 is shown in dashed line. To permit movement of the cord 262 in the release direction 94, the lever 240 can be pivoted at its pivot axis 271 (FIG. 8) in a first rotational direction 270 (FIGS. 8, 10) from its locking position thereby increasing the dimension 264. To prevent movement of the cord 262 in the release direction 94, the lever can be pivoted in an opposite second rotational direction 272 (FIGS. 8, 10) back to its locking position thereby decreasing and/or minimizing the dimension 264. The pivot axis 271 defined by the fastener 220 and aligned holes 216 is perpendicular to and offset from the longitudinal axis 90 as shown in FIGS. 5 and 8.

The handle 252 extends longitudinally in the pull direction 92 from the laterally extending portion 250 and pawl, in coordination with the inclination of the pawl-mounted cord engagement teeth 248, establishing an automatic locking function of the cord ratchet. When a cord-actuated device 60, illustrated as a pruning device, is mounted on a pole and raised for use, the lever 240 extends generally downward from the yoke 200 such that gravity biases the lever 240 toward its locking position defined by the handle 252 being nearest the longitudinal axis 90 and pole. Even when a pole in use is not directed entirely vertically, as when only partly inclined thus extending also horizontally, a user provided instructions and/or relying on intuition can rotate the pole in use to place the cord ratchet along the top dorsal side of the pole where gravity has even greater effect on biasing the lever 240 toward its locking position.

The cord ratchet 100 may find many uses according to the intentions of many users. Use with a pole pruner is particularly expected. Typical pole pruners are designed to be attached at the top end of a pole, so they can reach elevated tree branches. The pole pruners are activated by pulling a lever which in turn moves a blade against a fixed anvil, which cuts the tree branch captured between the two. The lever is typically attached to a rope that is long enough to reach the user at the bottom end of the pole, so that the user can pull the rope, activate the lever of the cutting tool and cut the desired tree branch.

With reference at least to the pole pruner assembly 280 of FIG. 10, the cord ratchet 100 can be mounted on the pole 50 of a pole pruner, and the cord 262 of the cord-actuated device 60 can be threaded through the cord path 260, or the lever 240 can be removed to allow the cord 262 that actuates the cord-actuated device 60 to be inserted mid-span. Because of its inherent design, the cord 262 extending from the device 60 is allowed to flow through in only the pull direction 92. The engagements of the cord with the pawl 242 and along the floor 212 of the channel 210 automatically securely grab the cord 262 in place whenever a force occurs in the release direction 94, but the cord 262 can slide through when force is applied in the pull direction 92. This means that the user can pull the cord 262 for any length of cord that is most convenient a given user anatomy, and then let go of the cord 262 essentially automatically locking cord unless and/or until the lever is in its release position by the handle 252 being pivoted away from the longitudinal axis 90 as represented in dashed line in FIG. 10.

Typically, the spring bias or other elastic return for of a pruner will pull the cord 262 in the release direction 94, allowing the engagement teeth of the cord ratchet 100 to grab the cord 262 and prevent any movement. As such, the movement achieved as part of a user's arm stroke is not lost, even if the blade movement of a tool such as a pruner did not complete. The user is then free to reposition his/her arm to initiate a new pull stroke. This process of pulling, stopping, repositioning and pulling again can be repeated as many times as necessary for the blade movement cutting action of a tool to complete. This allows the user to always exert the maximum force possible with each partial cord pull stroke, regardless of the position of the blade along its cutting movement. This ensures a most efficient cut and comfortable use. When a blade in a pruning tool has reached its end of travel, the cord ratchet 100 can be reset by moving the lever 240 into its release position by pivoting the handle 252 in the longitudinal direction 270. This will increase the dimension 264 of the cord path 260 between the pawl 242 and floor 212, releasing the engagement teeth from the cord 262 and allowing the cord to travel in the release direction 94 so the blade of a tool can return to its open position until a new pull sequence is initiated.

Each arm pull stroke can be accomplished exerting the greatest amount of force, regardless of the position of the blade, the anatomy of the user, or the thickness of the limb being cut. The pole can always be grasped securely by the user, because there is never a need to hold the pole and rope with the same hand. This increases the safety of the pruning operation.

Each pull stroke is safer and more ergonomic because the user can optimize the beginning and end point arm position, as well as the actual arm movement between the two, to his/her specific anatomy. There is never a need for a “more aggressive initial arm position.” The whole pruning process takes less time, because there is no time lost to reposition the arm between pulls or lost pulls. Also, because each pull can use the maximum amount of force possible, which accounts for faster pulls.

It is worth noting that the cutting device will offer resistance as it is being actuated. Part of this resistance comes from inherent design features in the product, like friction and geometry, but most importantly from the fact that the blade movement is biased in the open position with a spring or other elastic return force element. Additional resistance is offered by the tree limb itself as it is being cut. While this resistance varies with the different mechanical advantages present in the different product variations, tension in the cord 262 must be exerted by the user throughout the travel of the cord 262, especially in the pull direction 92, to do the job.

From an anatomical point of view, this need for persistent force presents a challenge. The user can exert the greatest amount of force when the arm is fully extended. The user can position his/her arm and grasp the rope in such a way that as the pull action is executed, the greatest force is exerted. However, as the cord is being pulled and the arm flexed, the amount of force exerted by a typical user diminishes, and there is a point in the travel where little to no more force that can be exerted by the user. In a single pulley product configuration, this point may more or less coincide with the rope pull full length. This means that with one full arm stroke a complete blade cut movement can be accomplished.

However, with double (or more) pulley cutting tools, the pull stroke may be longer than what a user's arm can provide in a single movement of an arm. Thus, the point of diminished arm force occurs somewhere along the cord travel without completion of a cutting sequence of the tool. Thus, the latter half of the blade cutting action is compromised without use of the cord ratchet 100. Without the cord ratchet 100, the user has two options. The user can either hold the cord in position, and reposition the arm to execute a second arm stroke without losing the blade travel already accomplished, which is very difficult because of the blade mechanism's spring-bias to the open position. This might require momentarily holding the rope with the same hand that is holding the pole, which might be dangerous. The user can otherwise start all over with a more aggressive initial arm position to try and complete the full blade travel with one arm stroke. Neither if these options available without the use of a cord ratchet 100 are ideal.

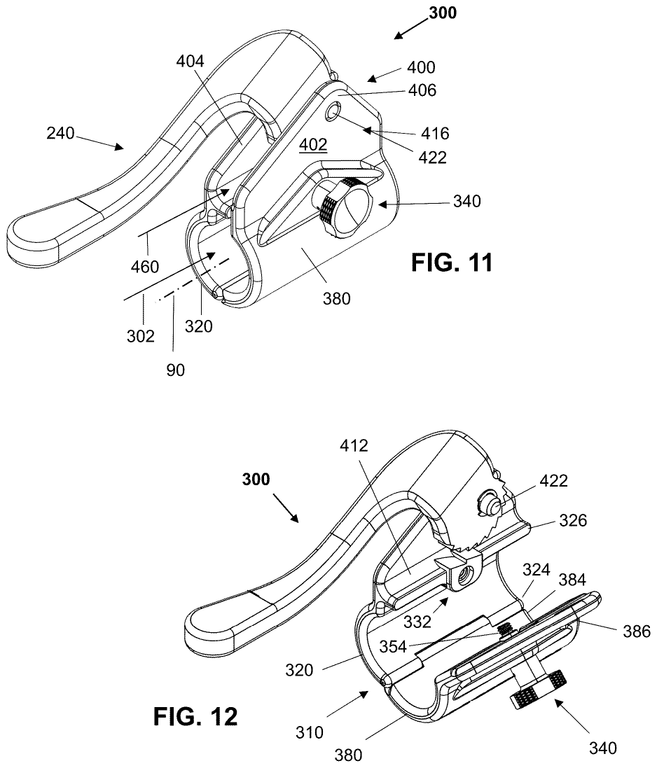

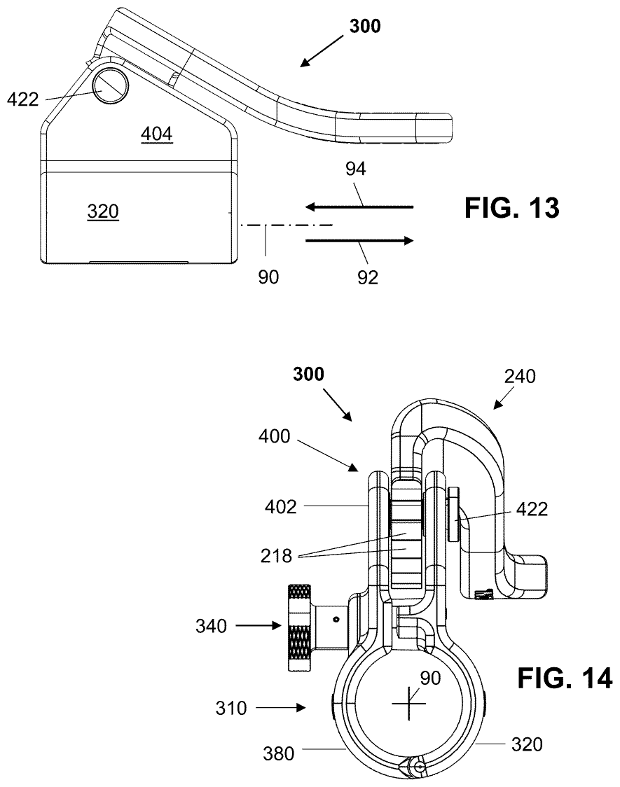

FIGS. 11-15 illustrate a cord ratchet 300 according to another embodiment, differentiated from the above-described cord ratchet 100 at least by way of some features to which the following description are directed. Many features and functions of the cord ratchet 300, except those expressly illustrated or described as different, are sufficiently similar to those already described in the preceding descriptions of the cord ratchet 300 such that separate descriptions are not needed.

Like the cord ratchet 100, the cord ratchet 300 has a mounting base 310 including a main body 320 and a clasp 380 that hinges open for placing the cord ratchet 300 on a pole. In several non-exhaustive distinctions worth noting, according to the cord ratchet 300 (FIGS. 11-12), as the clasp 380 opens, both the pole bore 302, and the cord path 460 are opened as the lever 240 remains attached to the main body 320. One flange 402 is connected to and hinges with the clasp 380, as the other flange 404 remains fixed with the main body 320 such that the cord path is only closely flanked by both of the flanges 402 and 402 when the clasp 380 is in the closed position. Each flange (402, 404) has a respective mounting hole 416 at its apex 406. The mounting holes 416 are aligned when the clasp is closed to receive respective portions of the lever fastener 420 having a portion that serves as an axle by which the pivoting lever 240 is mounted. The flanges thus define a yoke 400 (FIG. 14), when the clasp is in the closed position, on which the lever 240 pivots in use.

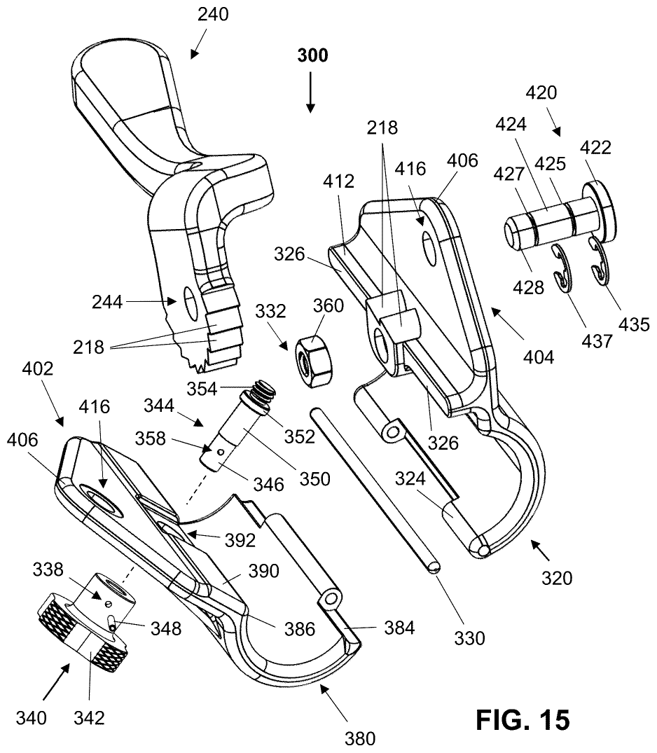

The main body 320 is formed as a rigid circumferential shell in the illustrated embodiment, having a longitudinally extending first edge 324 (FIG. 12) and an opposite second edge 326. The clasp 380, also formed as a rigid circumferential shell, similarly has a first longitudinally extending first edge 384 and an opposite second edge 386. The first edge 324 is pivotally attached to the first edge 384. A hinge design with a pin 330 (FIG. 15) is represented in drawings. Other pivotal connections, including a living hinge, are within the scope of these descriptions.

The fixed flange 404 extends outward from the main body 320. The floor 412 of the cord path 460 is defined by an outer surface of the main body 320 between the flange 404 and second edge 326 of the main body opposite the first edge 324. A clasp plate 390 (FIG. 15) extends outward from the second edge 386 of the clasp opposite the first edge 384. The clasp plate 390 (FIG. 15) abuts the second edge 326 of the main body 320 when the clasp is closed. The clasp fastener 340 (FIG. 12) is illustrated as an assembled thumb screw generally carried by the clasp 380. The clasp fastener 340 is shown disassembled in (FIG. 15) as having a head 342 represented as a knurled knob and a staged shank 344 that extends from the head. The shank 344 has an insertion tip 346 as a head-proximal end, a smooth medial portion 350 extending from the insertion tip, a widened trapping collar 352 at a distal end of the smooth medial portion 350, and a threaded end 354 extending from the trapping collar.

The insertion tip 346 is received by the head 342 to assemble the clasp fastener 340 and attach the clasp fastener 340 to a plate 390 of the clasp 380. The insertion tip 346 is fixed to and within the head 342 by a transverse pin 348 permanently pressed into a receiving hole 338 in the head 342 aligned with a receiving hole 358 in the tip 346. The smooth cylindrical medial portion 350 of the shank 344 connected to the insertion tip 346 freely turns in a hole 392 through the plate 390, which is captured between the head 342 and trapping collar 352, such that the clasp fastener 340 swings with the clasp plate 390 as the clasp 380 opens as in FIG. 12. The clasp fastener 340 is thus captured and carried by the clasp. Once installed on the clasp it cannot be disassembled.

The threaded end 354 of the shank 344 engages a threaded hole 332 defined along the second edge 326 of the main body of the main body 320. The threaded hole 332 in the cord ratchet 300 is defined by the threaded interior of a captured nut 360 carried by the main body. By threadingly engaging the nut 360 of the main body 320, the clasp fastener 340 closes the pole bore 302 upon a pole for mounting where selected by a user. By disengaging the fastener 340 from the main body 320, the clasp 380 can pivot at its first edge 384 to open the mounting base 310 as shown in FIG. 12. This permits placement of the cord ratchet 300 to any position along a pole preferred by a user. The clasp 380 can then be pivoted to its closed position (FIGS. 11 and 14) and the fastener 340 is used to re-engage the main body 320 by turning the threaded end 354 into the nut 360, thereby tightening the mounting base 310 around the pole and fixing its location. The head 342 is manually turned to tighten the mounting base 310 around the pole and fix its location. When the clasp 340 is in the closed position, the circumference defined by the clasp and the body is slightly smaller than that of the pole that it attaches to, such that enough friction is created so that no relative movement between the pole and the ratchet device is possible.

Furthermore, in the cord ratchet 300, the lever fastener 420 (FIG. 15) is shown as having a smooth head 422 and a shank 424 having spaced notches, referenced as a head proximal notch 425 and a head distal notch 427 between which the lever 240 hinges at its pivot hole 244 on a smooth portion of the shank 424 therebetween serving as an axle. The lever 240 is pivotally mounted on the lever fastener 420 and trapped at the smooth portion 426 between a pair of spaced snap rings, referenced as a head proximal ring 435 and a head distal ring 437 engaging and snapped or clipped into, respectively, the head proximal notch 425 and a head distal notch 427. Thus, both the clasp fastener 340 and the lever fastener 420 are captured and carried by the cord ratchet 300 preventing their loss.

When the clasp is closed, the mounting holes 416 at the apexes 406 of the flanges (402, 404) are aligned. A beveled terminus 428 of the shank 424 the lever fastener 420 (FIG. 15) extending beyond the head distal notch 427 passes into the mounting hole 416 of the clasp flange 402 as the clasp closes, stabilizing the lever fastener 420.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A cord ratchet device comprising:
a mounting base defining a longitudinally extending pole channel for receiving a pole;
a yoke connected to the mounting base, the yoke defining a cord path; and
a lever pivotally mounted on the yoke, the lever comprising a pawl for engaging a cord by movement of the pawl thereby varying a dimension of the cord path.

2. The cord ratchet device of claim 1, wherein:
the pawl automatically permits cord movement in a first longitudinal direction; and
the pawl automatically prevents cord movement in an opposite second longitudinal direction.

3. The cord ratchet device of claim 1, wherein the yoke comprises two flanges between which the cord path is defined.

4. The cord ratchet device of claim 3, wherein the lever is pivotally mounted to the yoke by way of the pawl being pivotally mounted to at least one of the two flanges.

5. The cord ratchet device of claim 4, wherein the cord path is defined between the two flanges and between the pawl and a floor defined by an exterior of the mounting base between the two flanges, and wherein said dimension of the cord path is defined between the pawl and floor.

6. The cord ratchet device of claim 5, wherein the pawl is pivotally mounted to the yoke at a pivot axis, wherein an end of the pawl has a curved edge along which a varying radius from the pivot is defined thereby varying said dimension of the cord path when the lever is pivoted.

7. The cord ratchet device of claim 6, wherein the lever has a locking position, at which said dimension is minimized, and a release position defined by pivoting the lever away from the locking position thereby increasing said dimension.

8. The cord ratchet device of claim 6, wherein said dimension of the cord path is defined between the floor and a tangent point along the curved edge nearest the floor.

9. The cord ratchet device of claim 8, further comprising pawl-mounted engagement teeth distributed along the curved edge and extended toward the floor and into the cord path.

10. The cord ratchet device of claim 9, further comprising fixed engagement teeth extending from the floor into the cord path and toward the pawl.

11. The cord ratchet device of claim 10, wherein the fixed engagement teeth are inclined in a longitudinal first direction, and the pawl-mounted cord engagement teeth are inclined in the longitudinal first direction.

12. The cord ratchet device of claim 4, further comprising an axle passed through a pivot hole defined through the pawl at the pivot axis, the axle mounting the lever to the yoke.

13. The cord ratchet device of claim 12, wherein:
the axle is defined by a lever fastener comprising a shank by which the lever is pivotally mounted to the yoke; and
the shank comprises a first portion received in a mounting hole in a first of the two flanges and a second portion received in a mounting hole in a second of the two flanges.

14. The cord ratchet device of claim 4, wherein the lever comprises:
a laterally extending portion connected to the pawl;
an intermediate portion connected to the laterally extending portion; and
a longitudinally extending handle connected to the intermediate portion,
wherein the intermediate portion brings an end of the handle close to a pole for easy manual actuation and renders a center of gravity such the lever falls into the closed position automatically by gravity when the pole is in a vertical orientation thereby locking a cord automatically.

15. The cord ratchet device of claim 1, wherein:
the mounting base comprises a main body and a clasp pivotally connected to the main body;
the main body defines the pole channel;
the clasp defines another longitudinally extending channel;
the pole channel and the channel of the clasp together surround a longitudinal axis and define a pole bore for surrounding the pole when the clasp is in a closed position thereof.

16. The cord ratchet device of claim 15, wherein:
the main body comprises a circumferential shell having a longitudinally extending first edge and an opposite longitudinally extending second edge;
the clasp comprises a circumferential shell having a longitudinally extending first edge and an opposite longitudinally extending second edge; and
the first edge of the clasp is pivotally attached to the first edge of the main body.

17. The cord ratchet device of claim 16, further comprising a clasp fastener releasably coupling the second edge of the clasp to the second edge of the main body thereby releasably maintaining the clasp in the closed position.

18. The cord ratchet device of claim 17, wherein:
the second edge of the main body comprises a threaded hole;
the second edge of the clasp comprises a plate that carries the clasp fastener; and
the clasp fastener comprises a shank having a threaded end releasably engaging the threaded hole.

19. The cord ratchet device of claim 18, wherein the clasp fastener is captured and carried by the clasp.

20. An assembly comprising:
a longitudinally extending pole;
a device mounted on an end of the pole, the device comprising a cord, the device being actuated by manual pulling of the cord in a pull direction along the pole; and
a cord rachet device comprising:
a mounting base mounted on the pole;
a yoke rigidly connected to the mounting base, the yoke defining a cord path through which the cord extends; and
a lever pivotally mounted on the yoke, the lever comprising a pawl for engaging the cord by movement of the pawl thereby varying a dimension of the cord path.

21. The assembly of claim 20, wherein:
the pawl automatically permits cord movement in the pull direction; and
the pawl automatically prevents cord movement in an opposite release direction.
